(19) United States
(12) Patent Application Publication
(10) Pub. No.: US 2013/0088485 A1
(43) Pub. Date: Apr. 11, 2013

(54) Method of storing or transmitting auto-stereoscopic images

(71) Applicant: John Gerald Chapman, (US)

(72) Inventor: John Gerald Chapman, (US)

(21) Appl. No.: 13/269,629

(22) Filed: Oct. 10, 2011

(51) Int. Cl. G06T 15/00

(52) U.S. Cl. 345/419

(57) ABSTRACT

A method of preparing a file representing a multi-view image for 3D auto-stereoscopic viewing whereby the individual view images are reduced to a resolution equivalent to that observed for an individual view. The resolution reduction is achieved by selecting the individual sub-pixels that would be remain after applying a mask to full-resolution images. The images are tiled into a single image and compressed for storage or transmission. In order to display the tiled image, a software operation splices together the individual images from the tiled image to produce a rendered image suitable for coupling with a lenticular lense for 3D viewing.

### FIELD of INVENTION

This patent relates to software for the production and relay of images files used to produce 3D images, particularly for multi-view (glasses-free) auto-stereoscopic viewing but also for glasses-based systems, such as those that use polarised light.

### DESCRIPTION of PRIOR ART

The technology of 3D displays or televisions is based on methods to deliver a different image to each eye of a viewer and thereby give the illusion of 3D through object images exhibiting parallax. The early most common form of 3D imagery was by means of different colours representing left and right eye views for which an observer would wear glasses with different coloured filters for each eye. Later, shutter glasses were introduced where liquid crystal shutters would alternate the opaque status of the lense in front of each eye, and the shuttering would be synchronised to images displayed on a screen. More recently displays have been produced in which adjacent pixels are polarised 90 degrees to one another, normally horizontally and vertically, while glasses have a left lense that is polarised say horizontally a the right lense—vertically. In this instance different images can be displayed to each eye of an observer.

All the above methods are based on two views—a left and a right. A different method which does not require the use of special glasses is called auto-stereoscopic and it normally has multi-views, typically eight or nine though can be as high as 18 or more. Such 3D systems use an LCD screen over which is placed a lenticular lense sheet comprising many cylindrical lenses which serve to focus sets of sub-pixels corresponding to a particular view as described in U.S. Pat. No. 6,064,424.

Because each sub-pixel corresponds to a different image to that of horizontally adjacent sub-pixels, then the use of any image compression is highly limited and can generally not be used. Consequently the file sizes for such auto-stereoscopic images are very large which becomes a particular issue when movies are considered.

One way to reduce the file size is to transmit the individual images for each view and then splice them together in a processor which addresses the LCD screen. This invention proposes an alternative method which is to tile the individual view images at a resolution equivalent to the screen resolution divided by the quantity of views. For example a screen with a resolution of 1920×1080 pixels used in conjunction with a 9-view lenticular lense sheet would have effective individual image resolutions of 640×360 pixels. The tiled image comprising each of the views can then be compressed using such algorithms as jpeg or jpeg2000, prior to transmitting or storing the file.

It has been found that the image quality of the final rendered or spliced image is higher if the individual view images, hereinafter referred to as sub-images, used to construct the final image are each themselves of the full screen resolution. However such file sizes prior to the rendering operation would be much larger than would otherwise be obtained. In the instance of a 9-view system and a 1920×1080 display it would clearly be nine times larger than having a composite of nine images of 640×360 pixels.

The object of this invention is to provide a low resolution sub-image which when rendered to produce a 3D image will have a similar quality as a rendered image generated from sub-images of full resolution. These images apply to stills as well as movies which comprise sequences of stills.

### SUMMARY OF THE INVENTION

This invention is said to reside in a method of storing or transmitting image files for 3D display, whereby sub-images that represent individual views are generated at the full resolution of a screen onto which a 3D image is to be displayed, and said sub-images are reduced in pixel count to a figure that is equivalent to the screen resolution divided by the number of views and where the reduction is characterised by assigning each pixel of a sub-image with RGB sub-pixel values which correspond to those of the sub-pixels that would be preserved if a 3D image was rendered using full resolution images, and where the sub-images are tiled to present a single image file which is compressed using an image compression algorithm.

A further form of the invention is to extract through a mapping operation the individual views from a fully rendered 3D image, whereby the pixel RGB composition is derived from the RGB values diagonally aligned with the axis of a lenticular lense for which the image has been constructed. The individual views are then tiled and compressed as described in the preceding paragraph.

The image compression algorithm can for example be the familiar jpeg or in the case of movies, mpeg. The compressed file is transmitted either locally or remotely to a processor which remaps each sub-pixel to generate an image that corresponds to a rendered image suitable for display on a screen which is optically coupled to a lenticular lense enabling 3D viewing.

Preferably the tiled image has an aspect ratio and pixel count that is the same as that of the display and the compression applied reduces the file size by a factor of at least ten.

### BRIEF DESCRIPTION OF THE DRAWINGS

The invention can be better appreciated with reference to examples and the accompanying illustrations in which;

FIG. 1 shows a schematic diagram of the processing steps to produce a 3D image from multiple views.

FIG. 2 shows the mapping to reduce a full resolution single image to a sub-image.

FIG. 3 shows the mapping to transform a tiled image to an interlaced image ready for 3D viewing.

FIG. 4 shows a schematic of how a fully rendered 3D image is deconstructed and tiled to be suitable for compression.

### DESCRIPTION OF THE PREFERRED EMBODIMENTS

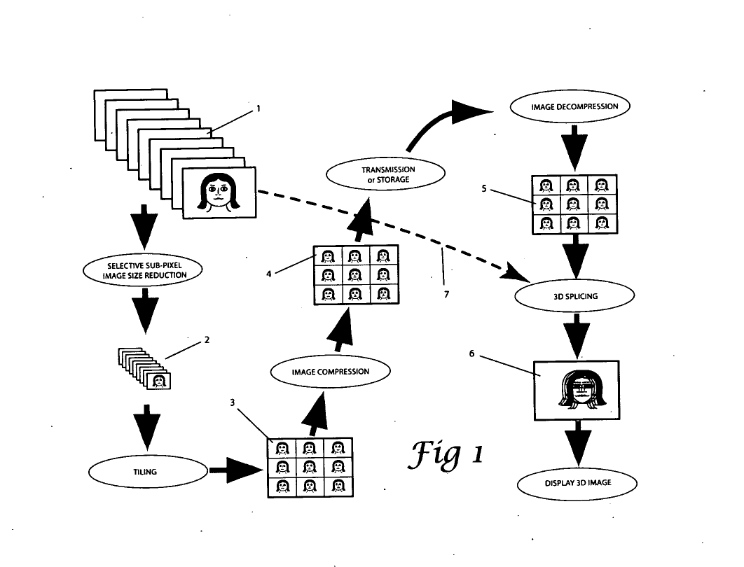

A common number of views for auto-stereoscopic viewing is nine or with high resolution screens, eighteen views may be considered. Each of the views can be generated either by photographic means or by 3D animation. In the following discussion a nine-view arrangement is applied to a display having a resolution of 1920×1080 pixels coupled to a lenticular lense having lenselets inclined to vertical at 18.3 degrees. FIG. 1 shows a schematic of how a set of sub-images is processed to yield a final 3D image. Referring to the figure, a set of individual views, 1, are generated at 1920×1080 resolution. These sub-images are reduced in size using a mapping technique the subject of this invention, which will be described later, to produce a reduced-size set, 2. This image reduction can be applied to each of the 9 views and the resultant images can be tiled to form a 1920×1080 image, 3, comprising the nine sub-images images. The adjacent pixels in the image, 3, belong to the same sub-image, except at the edges of each tile and therefore image compression will affect the quality of a single view but not affect the overall 3D effect. The process therefore applies an image compression to produce a compressed image, 4. Applying a mid-level jpeg compression to a typical 1920×1080 image results in a file size of about 500 kB which represents more than a 90% reduction from a typical lossless png file of 6 MB.

The compressed file may be either stored on memory drives, such as hard drives, DVDs or solid-state chips or transmitted to another memory storage device or to a remote processor connected to a display. The processor connected to a display includes software that decompresses the image file to produce (virtually) an image, 5, which is identical to the image, 4, prior to transmission or storage. The processor maps the tiled image 5 to produce a single spliced or rendered image, 6, with view assignments consistent with a 3D image. This image coupled to a lenticular lense will produce

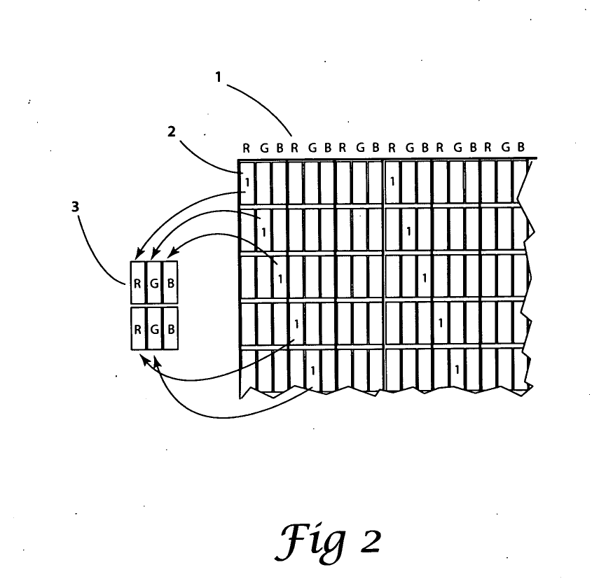

The image reduction method to generate the set of images, 2, will now be described with reference to FIG. 2. FIG. 2 shows a small section of an LCD or equivalent screen which comprises columns, 1, of red, green and blue (R,G,B respectively) sub-pixels. For any particular row, every ninth sub-pixel is associated with a specific view. This spacing would be every 18 sub-pixels in the instance of an 18-view display. If view 1 is considered, a diagonal collection of sub-pixels is associated with the view and includes the red sub-pixel, 2. These diagonal columns of sub-pixels are those which will be visible through a lenticular lense, the axis of which corresponds to that of the diagonal direction, which in the case of a 9-view system is near 18.4 degrees off vertical.

It will be apparent that a mask can be applied to the image to discard those sub-pixels that do not pertain to the view of interest, thereby leaving only those sub-pixels showing an annotation of ‘1’ in the figure. The figure shows how sub-pixels spanning three rows are mapped into a single row. Extending this mapping principle across the image allows a reduction of the pixel count, in this example, by a factor of nine and yet there is no loss of any of the information for each view.

Such mapping to reduce the image size can be described as selective sub-pixel size reduction. It will be clear from FIG. 2 that the example 1920×1080 sub-image can be reduced to 640×360 pixels and yet still contain all the sub-pixels that would remain after applying a view-mask to the full resolution image.

It is worth pointing out that hitherto it has been common practice to apply the masks to each of the views and compile or render a single 1920×1080 image as shown by the processing path arrow 7 in FIG. 1. However it will be appreciated that adjacent sub-pixels in the rendered image belong to a different view and that image compression cannot be applied as the image information in one view would affect that in an adjacent view. The image in one view in many areas may bear little in common with an adjacent view and so compression would result in a poor 3D effect.

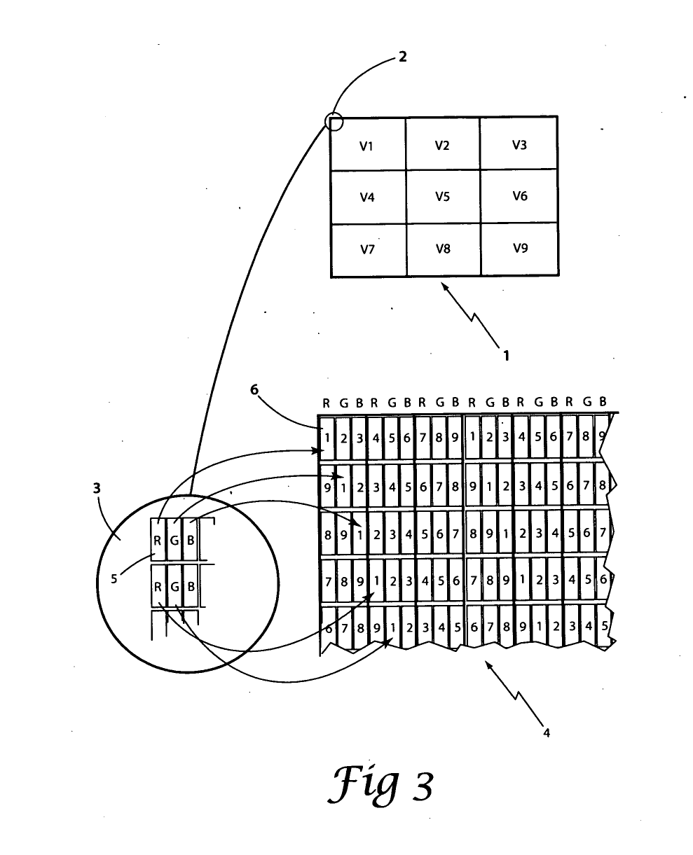

The sub-images constructed using the principle described in FIG. 2 can be tiled and subjected to the processes described above in relation to FIG. 1. To construct a final rendered image, the sub-pixels in the sub-images of the compressed tiled image undergo a reverse transformation or mapping as shown in FIG. 3.

Referring to FIG. 3 a tiled 9-view image, 1, comprises nine sub-images corresponding to nine views shown by the labels V1—V9. A small section, 2, of view 1 is enlarged in inset, 3, and shows individual sub-pixels. Each of these are mapped to form a rendered image, 4, using a transform as indicated by the sub-pixel, 5, mapping to sub-pixel, 6, in the rendered image. The arrows show how the other sub-pixels are mapped and it can recognised how this mapping can be extended to include the other sub-pixels in view 1 and also how each of the sub-pixels from the other views are mapped into the rendered image. The labels within each of the sub-pixels in the image 4 represent the views to which the sub-pixel is derived.

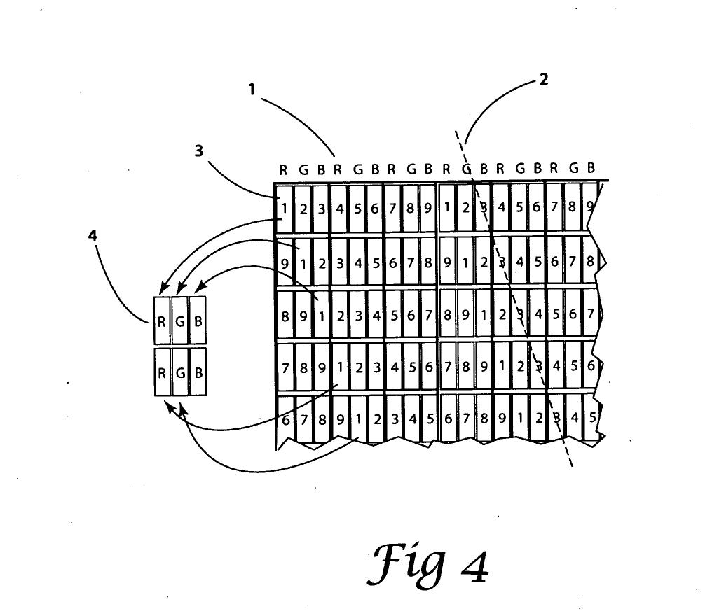

The invention also applies to images that have already been spliced or rendered as can be found in the output from some software packages that generate 3D rendered images. FIG. 4 shows the mapping operation applied to a small section of a rendered image in which the views assigned to each sub-pixel are annotated accordingly. Each of the columns is of an RGB colour, such as the red column 1. The view assignment is consistent with the axis 2 of a lenticular lense, in this instance overlying view 3, but this axis would translate sideways as an observer moves sideways.

The sub-pixels belonging to each view are mapped to an image featuring a tiled format, such that for view 1, the sub-pixel 3 forms the R component of a pixel 4 on a tiled image and the pattern is applied to the whole image. The sub-pixels for view 2 are mapped to the sub-image tile representing view 2, etc. Once this tiled image has been generated it represents image 3 in FIG. 1 to which compression can be applied.

For a 3D movie using this principle, the compression can be applied within each frame as for a still image, or between each frame or a combination of both. Movie compression methods such as mpeg can be used to advantage, applied to the uncompressed stills.

A second example is that of an 18-view 3D image on a 3840×2160 display. In this instance the vertical resolution is twice that of the horizontal resolution and the tiled image comprises six sub-images horizontally by three images vertically, each having a size of 640×720 pixels.

The resultant tiled image of size 3840×2160 can then be compressed as described in the aforementioned example and can reduce a full resolution PNG file to about 2 MB, which is less than 10% the size of a ‘ready-to-view’ rendered 3D image of the same pixel count.

The mapping exercises for both the pre-compression and post-compression stages are performed by either software programs or electronic chips that are coupled to a computer or processor. The code and execution of these programs would be rudimentary to someone skilled in the art.

The principle described above can be extended to pixel configurations comprising four sub-pixels, such as red, green, blue and yellow or red, green, blue and white.

It will be apparent that the invention allows for an effective means of significantly compressing still and video images for multiple views, while not severely compromising the quality of the final 3D viewing experience. While the above examples refer to nine and 18 views, it can in principle be applied to any quantity of views of two or more. And while the examples describe tiled formats that preserve the aspect ratio of the individual images, the aspect ratio is not limited to this and can for example be a long strip 9 or 18 sub-images wide.

Where image quality at the edges of the images are important, an improved tiling format has alternating columns of images flipped left to right, and alternating rows of images flipped vertically thereby making the adjacent pixels more similar at the interfaces between view tiles and so reducing artefacts from compression. In this instance the mapping to generate the rendered 3D image would have to be modified to that described above, but the detail of the mapping would be apparent to those skilled in the art.

1. A method of storing or transmitting image files for 3D display, whereby sub-images that represent individual views are generated at the full resolution of a screen onto which a 3D image is to be displayed, and said sub-images are reduced in pixel count to a figure that is equivalent to the screen resolution divided by the number of views and where the reduction is characterised by assigning each pixel of a sub-image with RGB sub-pixel values which correspond to those of the sub-pixels that would be preserved if a 3D image was rendered using full-resolution images, and where the sub-images are tiled to present a single image file which is compressed using an image compression algorithm.

2. A method as in claim 1 in which the compressed file is less than 20% the file size of the file size of the pre-compressed tiled image.

3. A method as in claim 1 where the image files correspond to those of a movie.

4. A method as in claim 1 in which the number of views is greater than seven.

5. A method of processing an interlaced 3D multi-view image for storage or compression whereby a mapping operation extracts individual views from the image, characterised by producing an image for each view in which the RGB composition of each pixel is extracted from the RGB values associated with each view of the multi-view image and whereby the individual views are then tiled to produce a tiled image.

6. A method as in claim 4, whereby the tiled image is compressed and stored electronically.

7. An electronic chip which performs the operation of reconstructing a multi-view tiled image as in claim 1, whereby sub-pixels from each of the sub-images are mapped to an interlaced image.
